(19) United States
(12) Patent Application Publication
(10) Pub. No.: US 2025/0367636 A1
(43) Pub. Date: Dec. 4, 2025

(54) METAL-ORGANIC FRAMEWORKS FOR THE REMOVAL OF NITRATE FROM AQUEOUS SOLUTIONS

(71) Applicant: Technische Universität Wien, Wien (AT)

(72) Inventors: Dominik EDER, Wien (AT); Shaghayegh NAGHDI, Wien (AT); Mohammad ZENDEHBAD, Wien (AT)

(21) Appl. No.: 18/874,003

(22) PCT Filed: Jun. 20, 2023
(86) PCT No.: PCT/AT2023/060191

§ 371 Date: Dec. 11, 2024

(30) Foreign Application Priority Data
Jun. 20, 2022 (AT) A 50439/2022

(51) Int. Cl. B01J 20/22; B01J 20/30; B01J 20/34; C02F 1/28; C02F 101/16; C07F 1/08

(52) U.S. Cl. CPC B01J 20/226; B01J 20/3085; B01J 20/3425; B01J 20/3475; C02F 1/285; C07F 1/08; C02F 2101/163; C02F 2303/16

(57) ABSTRACT

A metal-organic framework comprising [Cu₂(Hbtc)₂(bpe)₂]·(bpe) and/or [Cu₂(Hbtc)₂(bpy)₂(H₂O)₂]·(bpy), wherein bpe represents 1,2-bis(4-pyridyl)ethane, Hbtc represents benzene-1,3,5-tricarboxylic acid and bpy represents 4,4′-bipyridine; as well as the use of such compounds as an adsorbent.

The present invention relates to metal-organic frameworks. Furthermore, the invention relates to a method of adsorbing nitrate salts from an aqueous solution using an adsorbent. Finally, the invention relates to a method of producing metal-organic frameworks.

### BACKGROUND OF THE INVENTION

Nitrate salts are among the most problematic environmental pollutants due to their extensive use in agriculture. Moreover, the good water solubility of nitrate salts facilitates the distribution of nitrate ions in the soil and subsequently in the groundwater. High concentrations of nitrate salts lead to eutrophication of water bodies and have a negative impact on the quality of drinking water.

According to Directive 2006/118/EC of the European Parliament and of the Council of Dec. 12, 2006 on the protection of groundwater against pollution and deterioration, the limit value for NO₃⁻ in drinking water was set at a maximum of 50 mg/l. In areas with high loads of nitrate salt in the soil and in the groundwater, there is therefore a need to remove the nitrates.

In order to remove dissolved nitrate ions from aqueous solutions, various methods are used according to the prior art, such as, for example, reverse osmosis, ion exchange, biological denitrification, catalytic denitrification, electrodialysis, treatment with magnesium and chemical denitrification with iron.

However, such methods are sometimes complex, and sometimes they are not very efficient. In order to reduce environmental pollution, there is therefore a need for an improved method of removing nitrate ions from an aqueous solution.

### BRIEF DESCRIPTION OF THE INVENTION

It is therefore the object of the present invention to provide a method of adsorbing nitrate (NO₃⁻) from an aqueous solution, wherein said method has a higher adsorption capacity for NO₃⁻ than the prior art. Furthermore, it is the object of the present invention to provide a selective adsorbent for NO₃⁻.

This object is achieved on the one hand with a metal-organic framework comprising
[Cu₂(Hbtc)₂(bpe)₂](bpe) and/or
[Cu₂(Hbtc)₂(bpy)₂(H₂O)₂](bpy),
wherein
bpe represents 1,2-bis(4-pyridyl)ethane,
btc represents benzene-1,3,5-tricarboxylic acid (trimesic acid) and
bpy represents 4,4′-bipyridine.

One of the two metal-organic frameworks is [Cu₂(Hbtc)₂(bpe)₂](bpe), wherein bpe represents 1,2-bis(4-pyridyl)ethane and Hbtc represents benzene-1,3,5-tricarboxylate, hereinafter referred to as compound 1, MOF-1 or 1.

The other one of the two metal-organic frameworks is [Cu₂(Hbtc)₂(bpy)₂(H₂O)₂](bpy), wherein Hbtc represents benzene-1,3,5-tricarboxylic acid and bpy represents 4,4′-bipyridine, hereinafter referred to as compound 2, MOF-2 or 2.

Compounds 1 and 2 are metal-organic frameworks (MOFs).

Compounds 1 and 2 are suitable for use in an adsorbent or, respectively, as an adsorbent so that an adsorbent comprising compound 1 and/or compound 2 is provided.

On the other hand, the object is achieved with a method of removing nitrate (NO₃⁻) from an aqueous solution, wherein the aqueous solution is brought into contact with an adsorbent, characterized in that the adsorbent comprises compound 1 and/or compound 2.

The inventors have discovered that special metal-organic frameworks can adsorb nitrate ions (NO₃⁻) from aqueous solutions in a highly selective manner and with high yield. In general, the adsorption of nitrate ions using an adsorbent is considered to be more attractive in comparison to chemical processes, since adsorbents are environmentally friendly. Moreover, such methods are less expensive and faster when cost-effective adsorbents involving a simple regeneration are used.

Metal-organic frameworks (abbreviated as MOFs) constitute a class of organic-inorganic hybrid functional materials that are composed of inorganic building blocks and organic molecules as connecting elements between the inorganic building blocks and have a microporous structure.

The use of a MOFs as a non-specific adsorbent is generally known, as most MOFs have a high porosity and, as a result, a large surface area. The use for the adsorption of various contaminants has indeed already been described, but applications in aqueous systems have not yet been successfully used due to the relatively low stability of MOFs in aqueous environments.

In MOFs, water can lead to structural collapse, crystal phase transitions, morphological changes and defect formations.

Surprisingly, certain copper-based MOFs according to the invention which have two different ligands and are disclosed herein are not only stable in aqueous solutions, but also specific for the adsorption of NO₃⁻.

Copper is inexpensive and non-toxic and forms strong and selective complexing agents for NO₃⁻ with the ligands 1,2-bis(4-pyridyl)ethane, benzene-1,3,5-tricarboxylate and 4,4′-bipyridine as described. Compounds 1 and 2 prove to be stable over a wide pH range and a wide temperature range.

In contrast to known MOFs, compound 2 has a more complex structure with a distorted square-pyramidal shape around the copper atom. In compound 2, the copper (II) atom forms unique bonds with two carboxylate oxygen atoms from trimesic acid and two nitrogen atoms from the bpy ligands and an aqua ligand.

Compound 2 has a complex crystal structure with “zig-zag chains” which are interconnected and form layers. These layers are further interconnected, resulting in a three-dimensional structure. In addition, compound 2 has a unique connectivity pattern wherein both btc ligands and bpy ligands play a crucial role in the connection of adjacent copper (II) atoms.

### DETAILED DESCRIPTION OF THE INVENTION

Further details and advantages of the invention are described below using examples and figures.

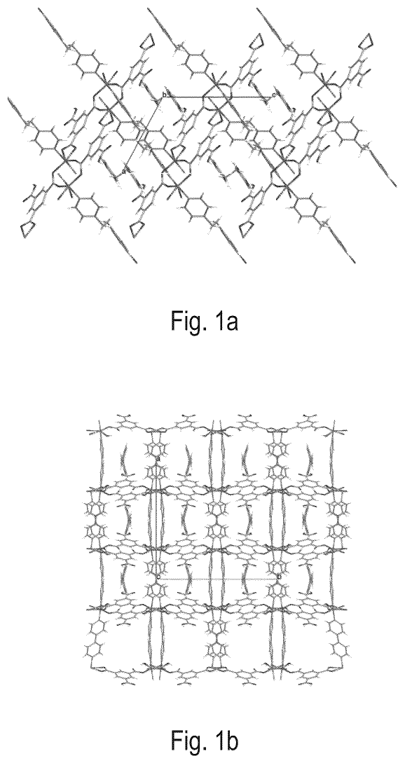

FIGS. 1a, 1b show the crystal structure of compound 1 in a projection along (FIG. 1a) and of compound 2 in a projection along (FIG. 1b), each in a “cap-stick” illustration.

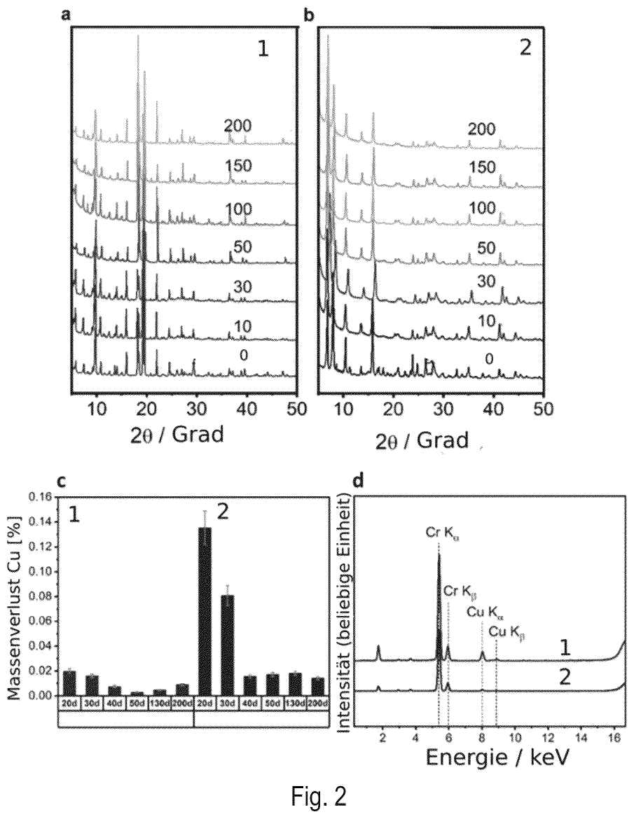

FIG. 2 shows results of stability tests on the two compounds 1 and 2, carried out in aqueous solutions over a period of 200 days.

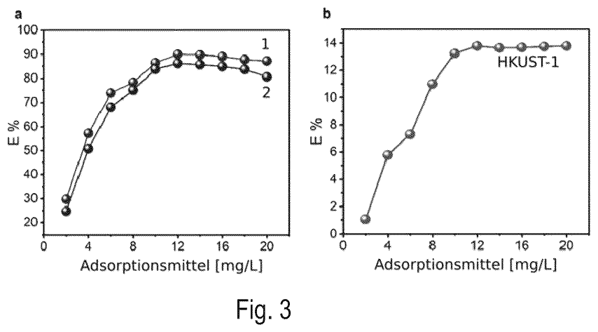

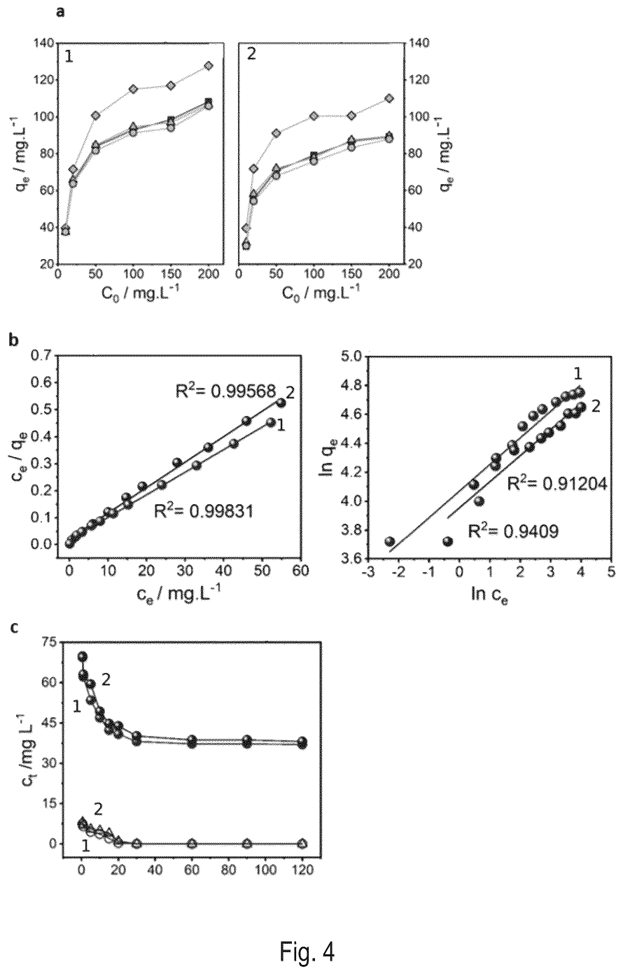

FIGS. 3, 4 show efficiency values of compounds 1 and 2 extracted from adsorption measurements regarding the adsorption of nitrates from aqueous solutions depending on the nitrate concentration/dose (FIG. 3) and in the presence of additional ions/contaminants (FIG. 4).

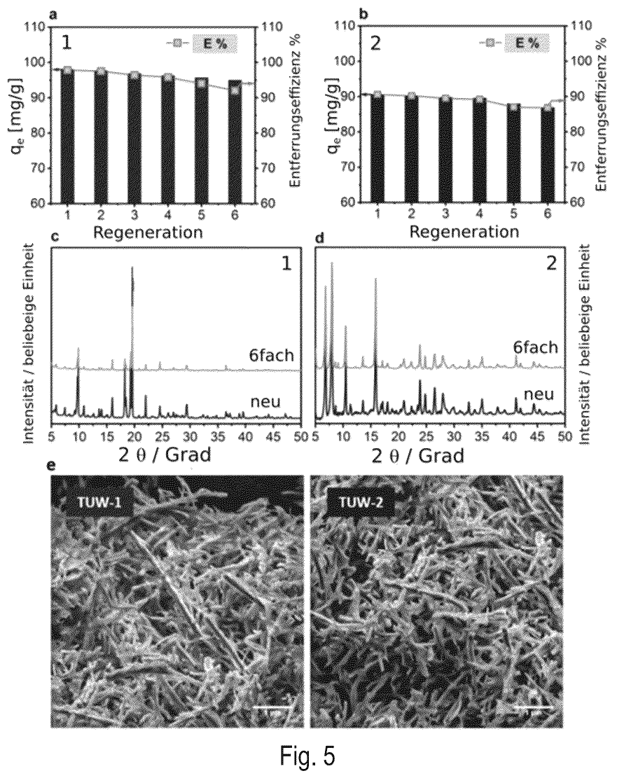

FIG. 5 shows the reproducibility and repeatability in terms of adsorption properties for compounds 1 and 2.

The structural and physicochemical properties of copper-based MOF-1 and MOF-2 were described by way of X-ray diffraction (XRD), transmission electron microscopy (TEM), Fourier-transform infrared spectroscopy (FTIR), total reflection x-ray fluorescence analysis (TRFA) and N₂ physisorption. The influence of various factors on nitrate removal efficiency and adsorption capacity, including adsorbent dosage, exposure time, competing ions and recyclability, was investigated.

### Synthesis of Compounds 1 and 2

### Compound 1: Synthesis of [Cu₂(Hbtc)₂(bpe)₂](bpe)

In an exemplary experiment, copper(II) acetate monohydrate (0.199 g, 1 mmol) was dissolved in 15 mL H₂O under gentle stirring. This first solution was added to a second solution, the second solution consisting of benzene-1,3,5-tricarboxylic acid (Hbtc; 0.141 g; 0.67 mmol), 1,2-bis(4-pyridyl)ethane (bpe; 0.184 g; 1 mmol) and NaOH (0.080 g, 2 mmol) in 15 mL mL H₂O.

Subsequently, this mixture was sealed in a 40 mL autoclave made of stainless steel and lined with Teflon and was heated to 120° C. for approximately 24 h. After cooling to room temperature, the obtained product was filtered and washed with 100 ml distilled water. The resulting solid was dried over night in a vacuum oven at 50° C.

### Compound 2: Synthesis of [Cu₂(Hbtc)₂(bpy)₂(H₂O)₂]·(bpy)

According to a method similar to the synthesis of [Cu₂(Hbtc)₂(bpe)₂](bpe), for the synthesis of [Cu₂(Hbtc)₂(bpy)₂(H₂O)₂]·(bpy), 4,4′-bipyridine (0.156 g=1 mmol) was first dissolved in 15 mL H₂O and was added to a solution of copper (II) acetate monohydrate (0.199 g, 1 mmol) with benzene-1,3,5-tricarboxylic acid in 15 mL H₂O.

Subsequently, this mixture was sealed in a 40 mL autoclave made of stainless steel and lined with Teflon and was heated to 120° C. for approximately 24 h. The resulting dark blue solid was filtered through a dense paper filter. The blue raw product was washed with distilled water, filtered off, and dried over night in a vacuum oven at 50° C.

It is evident in FIG. 1a that, in compound 1, the copper(II) atom has a coordination number of five with four short bonds of a similar length (approx. 2.0 Å) to two N atoms (N1, N2) of trans-aligned bpe ligands and to two carboxylate O atoms (O3, O5) of two Hbtc ligands. The fifth ligating atom originates from a third carboxylate O atom (O4) at a greater distance of 2.23 Å and defines a distorted square-pyramidal shape (τ₅=0.285, with τ₅=0 for an ideal square pyramid and τ₅=1 for an ideal trigonal bipyramid).

It is evident in FIG. 1b that, in compound 2, the structure has a copper(II) atom with a coordination number of 5 in a distorted square-pyramidal shape (τ₅=0.306) and with a similar bond length distribution as in compound 1. Two carboxylate O atoms (O2, O5) and two trans-aligned N atoms of two bpy ligands (N1, N2) define the base of the pyramid at short distances of approx 2.0 Å. The top of the pyramid originates from an aqua ligand (O1W) at a greater distance of 2.32 Å. Likewise, the closest O atom from the central copper(II) atom is located at a considerably greater distance of 2.69 Å. Adjacent chains are located in parallel to extending layers via medium-strength hydrogen bonds between the aqua ligand and the non-coordinating carboxylate O atoms of the Hbtc ligands (O1, O6; O . . . O distances are between 2.69 Å and 2.74 Å, and OH . . . O angles are between 160° and 177°). Parallel layers are connected by the μ₂-bridging bpy ligands to form a three-dimensional structure which delimits channels in parallel to [001]. As in 1, the channels are filled by non-coordinating solvent molecules, in this case bpy, which, in turn, are linked via strong OH . . . N hydrogen bonds (O4 . . . N3=2.61 Å; O4-H4 . . . N3=166°) between the carboxylate group and the pyridine N atom.

### Synthesis of HKUST-1 (Cu-BTC) MOF

Cu(OAc)₂·H₂O (0.359 g, 1.8 mmol) and benzene-1,3,5-tricarboxylic acid (H₃btc; 0.210 g; 1.0 mmol) were ground by hand for 15 minutes. The resulting powder was washed with small amounts of DMF to remove unreacted starting material. Subsequently, the powder was air-dried over night, and HKUST-1 was isolated.

N₂ physisorption isotherms were measured at 77 K on a Micromeritics ASAP 2020 instrument. Prior to the measurement, samples were degassed under vacuum at 150° C. for 12 h. The total pore volume of all samples was estimated from the amount of nitrogen adsorbed at P/P₀=0.95. The apparent surface area was calculated using the Brunauer-Emmet-Teller (BET) equation. Relevant pore size distributions were calculated from the adsorption branch of the isotherms by applying the theory of Barrett, Joyner and Halenda (BJH).

Structural properties such as pore volume, average pore size or BET surface area of the metal-organic frameworks are summarized in Table 1.

TABLE 1
Properties of compound 1 and compound 2.

| | | Average pore | |
|---|---|---|---|
| MOF | Pore volume | size | BET surface area |
| 1 | 0.36 cm³/g | 8.32 nm | 559.42 m²/g |
| 2 | 0.24 cm³/g | 7.15 nm | 511.97 m²/g |
| HKUST-1 | 0.41 cm³/g | 14.20 nm | 563 m²/g |

### Stability Studies

In FIG. 2, the results of stability studies on the two compounds 1 and 2 in an aqueous solution after immersion in water are summarized. X-ray diffraction (XRD) studies were performed immediately after preparation (0), after 10, 30, 50, 100, 150 and 200 days. The X-ray diffraction studies of compound 1 are summarized in diagram a and those of compound 2 are summarized in diagram b, the intensity is in arbitrary units. The X-ray diffraction studies do not show any discernible structural changes over time so that no change in the crystallinity structure can be assumed, which suggests that both MOFs 1 and 2 with mixed ligands are unexpectedly stable in water at room temperature. Diagram c (FIG. 2) shows total X-ray fluorescence (TXRF) analyses over 20, 30, 40, 50, 130 and 200 days, which confirm that the fraction of metal ions (Cu ions) going into solution is negligible (error bars of approx. 10%). Diagram (d) shows spectra of the TXRF measurements after 200 days of immersion of the two MOFs 1 and 2 in water, showing peaks with respect to silicon, Ar, Ca (mainly from water), Cr (reference) and Kα and Kβ of Cu, respectively.

The stability of the framework structure in an aqueous environment is one of the most important factors to be considered when using MOFs for the treatment of aqueous pollutants. A stability that is too low has so far limited the use of MOFs in aqueous solutions. During hydrolysis, the reaction with water molecules causes the rupture of the ligand-metal bond.

For ligands substituted with water, the exchange is caused by water molecules embedded in the metal-ligand bond of the metal-organic framework, as in Equation 1:

$$M - L + {H}_{2} O \to M - ( {H}_{2} O ) … L \qquad Eq . 1$$

During hydrolysis, the metal-ligand interaction is broken up. Water molecules are broken down into HO and H as shown in Eq. 2, with HO interacting with the metal and H binding to the ligand:

$$M - L + {H}_{2} O \to M - ( OH ) + L H \qquad Eq . 2$$

The inventors evaluated the water stability of the MOFs by two different measurements, which are referred to below as “short-term” and “long-term” experiments. In the long-term experiments, the MOFs according to the invention were immersed in distilled water (pH: 6.8) and stored at room temperature for up to 120 days—a procedure which reflects most stability tests in the literature. Using XRD, changes in the framework structure were observed throughout the entire immersion time. Both 1 and 2 were stable for 200 days in water at room temperature without any noticeable structural changes (FIG. 2a). The fraction of metal ions going into solution is also negligibly low, thus enabling excellent repeatability (FIG. 5) of the adsorption measurements.

In the short-term experiment, the stability of MOFs in water at 100° C. was observed. The XRD studies of 1 and 2 showed no changes for up to 16 hours, which constitutes a remarkable level of stability.

In summary, both MOFs exhibit an unusually high stability in water both at room temperature and at 100° C., whereby they are the most stable MOFs known to date. The high water stability is due to a strong coordination of the two different ligands to Cu. However, the much lower stability of the MOF with only one ligand (HKUST-1, also called MOF-199), which lasts for only 3 days, indicates a synergistic contribution of both ligands.

### Adsorption of Nitrate

FIG. 3 shows the adsorption capacity of compounds 1 and 2 (diagram a) in comparison to the adsorbent HKUST-1. In the diagram, the influence of the dosage of the respective adsorbent (compound 1 and compound 2 in diagram a, HKUST-1 in diagram b) on the efficiency of nitrate removal is shown. In each case, the initial concentration of nitrate was 15 mg L⁻¹ at a pH value of 6.8 and a temperature of 25° C.

In FIG. 4, the adsorption capacity of compounds 1 (diagram a, on the left) and 2 (diagram a, on the right) is shown in the presence of various competing ions to demonstrate the specificity toward nitrate (♦ shows a nitrate solution, ● shows a nitrate solution in the presence of sulfate, ▴ shows a nitrate solution in the presence of chloride, ▪ shows a nitrate solution in the presence of phosphate). The initial concentration of nitrate was between 10 and 200 mg L⁻¹. The concentration of adsorbent was 12 mg L⁻¹ at a volume of 0.05 L (pH: 6.8; temperature: 25° C.). In comparison to nitrate, sulfate, chloride and phosphate, the specificity is significantly higher. Diagram b (on the left: Langmuir isotherm, on the right: Freundlich isotherm) shows adjusted results of the nitrate adsorption. In actual groundwater samples (diagram c), both compound 1 and compound 2 showed similar results. The groundwater samples were obtained from the western part of the urban aquifer in Mashhad (diagram c, bottom), initial concentration of nitrate=8.46 mg L⁻¹, and from the southern part of the urban aquifer in Mashhad (diagram c, top), initial concentration of nitrate=70.56 mg L⁻¹ (adsorbent dosage, 12 mg; volume=0.05 1; pH: 6.8; temperature: 25° C.), respectively.

The adsorption power of compound 1 and compound 2 with respect to the adsorption of nitrate was tested with aqueous solutions containing different adsorbent concentrations varying between 2 and 20 mg L⁻¹. FIG. 3a shows that the efficiency of nitrate removal (removal of nitrate over the total amount added in mol %) increased, even increasing almost linearly for low concentrations. Once the adsorbent dosage exceeded 12 mg L⁻¹, the removal efficiency of nitrate attained saturation. Therefore, the adsorbent dosage was set to 12 mg L⁻¹ for all subsequent adsorption experiments. The nitrate removal efficiency of 1 was 90.02 mol % at 1.5 mg L⁻¹ nitrate, slightly higher than that of 2 (86.2%, 2.07 mg L⁻¹ nitrate). Compared to other agents for NO₃⁻ removal, the adsorption efficiency was much better for 1 and 2 (see Table 2). This is even more remarkable considering that these values were obtained at pH 7. In the prior art, there are in fact lower adsorption powers for the removal of nitrate in water at pH values of 6.5 to 8.5, in comparison to pH 1.

TABLE 2
The adsorption efficiencies reported for some other nanomaterials
in comparison to MOFs 1 and 2 according to the invention.

| | | | | Initial | |
|---|---|---|---|---|---|
| | Adsorption | Amount of | | concentration of | |
| Nanomaterial | efficiency (mol %) | adsorbent | | NO₃⁻ | |
| Iron nanoparticles¹ | 41.4-59.7% | 1 | g/L | 20 | mg L⁻¹ |
| Pd-Ag nanoparticles² | 40% | 0.4 | g | 100 | mg L⁻¹ |
| Oxidized carbon | 70% | 50 | mg | 50 | mg L⁻¹ |
| Nanotubes³ | | | | | |
| C-Si nanocomposite⁴ | 44.89% | 100 | mg | 50 | mg L⁻¹ |
| CuO-NPs⁵ | 71.56-66.51% | 70 | mg | 0.08 | g/L |
| HKUST-1 | 14% | 12 | mg | 15 | mg L⁻¹ |
| 1 | 90.02% | 12 | mg | 15 | mg L⁻¹ |
| 2 | 86.2% | 12 | mg | 15 | mg L⁻¹ |

¹Wang, T.; Lin, J.; Chen, Z.; Megharaj, M.; Naidu, R. Green Synthesized Iron Nanoparticles by Green Tea and Eucalyptus Leaves Extracts Used for Removal of Nitrate in Aqueous Solution. Journal of Cleaner Production 2014, 83, 413-419. https://doi.org/10.1016/j.jclepro.2014.07.006.
²Tyagi, S.; Rawtani, D.; Khatri, N.; Tharmavaram, M. Strategies for Nitrate Removal from Aqueous Environment Using Nanotechnology: A Review. Journal of Water Process Engineering 2018, 21, 84-95. https://doi.org/10.1016/j.jwpe.2017.12.005.
³Ahmadzadeh Tofighy, M.; Mohammadi, T. Nitrate Removal from Water Using Functionalized Carbon Nanotube Sheets. Chemical Engineering Research and Design 2012, 90 (11), 1815-1822. https://doi.org/10.1016/j.cherd.2012.04.001.
⁴Muthu, M.; Ramachandran, D.; Hasan, N.; Jeevanandam, M.; Gopal, J.; Chun, S. Unprecedented Nitrate Adsorption Efficiency of Carbon-Silicon Nano Composites Prepared from Bamboo Leaves. Materials Chemistry and Physics 2017, 189, 12-21. https://doi.org/10.1016/j.matchemphys.2016.12.032.
⁵Rahdar, S.; Pal, K.; Mohammadi, L.; Rahdar, A.; Goharniya, Y.; Samani, S.; Kyzas, G. Z. Response Surface Methodology for the Removal of Nitrate Ions by Adsorption onto Copper Oxide Nanoparticles. Journal of Molecular Structure 2020, 129686. https://doi.org/10.1016/j.molstruc.2020.129686.

The adsorption kinetics was further investigated using Langmuir and Freundlich models. FIG. 4b shows the correlation of the nitrate adsorption as a function of contact time. The adsorption capacity increased rapidly within the first 20 minutes and attained saturation after 30 minutes with values of 58.54 mg g⁻¹ and 55.66 mg g⁻¹ for 1 and 2, respectively. Compared to the single-ligand MOF adsorption capacity, HKUST-1 attained saturation after 18 hours with a value of 14 mg g⁻¹.

The maximum capacities of the nitrate adsorption for 1 and 2 are calculated to be 119.42 mg g⁻ 1 and 105.93 mg g⁻¹, respectively. These values of qₘₐₓ are considerably higher than that of the MOF with a single ligand HKUST-1 of 9.69 mg g⁻¹ and that of commercial activated carbon of 1.22 mg g⁻¹.

### Analysis of Natural Water Samples

The above-mentioned analyses were carried out in water with specific nitrate concentrations in the absence of other ions. However, natural water systems contain many different inorganic ions (besides organic contaminants) that can compete with nitrates during the adsorption process. Therefore, 1 and 2 were tested in aqueous solutions containing a mixture of NO₃⁻ with chloride, sulfate and phosphate in equimolar amounts. The adsorption of nitrate on 1 and 2 was tracked as a function of time and depicted in FIG. 4a. FIG. 5 shows that the adsorbed amount of nitrate indeed decreases as a result of the introduction of competing anions, but the adsorbed amount of chloride, sulfate and phosphate remains small (<±5 mg g⁻¹ variation).

Upon closer inspection, the reduction in the efficiency of nitrate removal due to competing ions seems to be influenced in the order sulfate>chloride>phosphate.

Risks to human health as well as eutrophication problems in the reservoirs can be significantly minimized by eliminating nitrate from the water. Therefore, both MOFs for nitrate extraction were also evaluated from actual groundwater samples (FIG. 4c). Both MOFs were able to completely remove nitrates from water with an initial nitrate concentration (c₀) of 8.465 mg L⁻¹ within only 20 minutes. This confirms that the MOFs according to the invention are efficient adsorbents capable of rapidly and successfully removing low nitrate concentrations from actual water samples. In water samples with high concentrations (i.e., c₀=70.561 mg L−1), the extraction was almost 50%, whereby the amount of nitrate was still significantly reduced to below 50 mg L⁻¹.

### Regeneration of the Compounds

FIG. 5 shows the regenerability and repeatability in terms of the adsorption properties for the two compounds 1 (diagram a) and 2 (diagram b), wherein the adsorption capacity is maintained even after sixfold regeneration. In diagrams c and d, there are XRD data, and in diagrams e and f, there are electron micrographs showing the stability of the compounds even after six adsorption experiments.

The reusability of the MOFs is of utmost importance when it comes to the performance of a material. Therefore, the MOFs according to the invention were obtained up to six times from different water samples, and each time their structural properties were analyzed and their performance was tested for nitrate removal. FIG. 5a shows the same values for qₘₐₓ and adsorption efficiency for each one of the six reusability tests. XRD and TEM results (FIG. 5b) also illustrate the high structural stability of the two compounds during the adsorption measurements.

After the adsorption of nitrate, the metal-organic framework loaded with nitrate was centrifuged, collected and dried for regeneration. The dried powder was immersed in a saturated sodium chloride solution at pH=7.22 (without pH adjustment). After about 5 minutes, the solution was centrifuged and washed three times with water and ethanol before it was dried over night in a vacuum oven at 60° C. Thereafter, the metal-organic framework regenerated in this way could be used again for the subsequent nitrate adsorption. The recyclability of the metal-organic framework was examined six times according to the same method, wherein no significant loss in nitrate adsorption was seen.

1. A metal-organic framework comprising
[Cu₂(Hbtc)₂(bpe)₂]·(bpe),
[Cu₂(Hbtc)₂(bpy)₂(H₂O)₂]·(bpy), or
a combination thereof,
wherein,
bpe represents 1,2-bis(4-pyridyl) ethane,
Hbtc represents benzene-1,3,5-tricarboxylic acid and
bpy represents 4,4′-bipyridine.

2. A metal-organic framework [Cu₂(Hbtc)₂(bpe)₂](bpe), wherein bpe represents 1,2-bis(4-pyridyl) ethane and Hbtc represents benzene-1,3,5-tricarboxylate.

3. A metal-organic framework [Cu₂(Hbtc)₂(bpy)₂(H₂O)₂]·(bpy), wherein Hbtc represents benzene-1,3,5-tricarboxylic acid and bpy represents 4,4′-bipyridine.

4. An adsorbent comprising a metal-organic compound according to claim 1.

5. A method of removing nitrate (NO₃⁻) from an aqueous solution, wherein the method comprises contacting the aqueous solution with an adsorbent, wherein the adsorbent comprises a metal-organic compound according to claim 1.

6. A method according to claim 5, wherein the amount of adsorbent ranges between 2 and 20 mg L₋₁.

7. A method of regenerating an adsorbent from the method according to claim 5, wherein the nitrate-containing adsorbent is brought into contact in a saturated solution from NaCl and is then purified with water and isolated.

8. A method of preparing a compound of claim 1, wherein an aqueous solution of a copper(II) salt, is reacted with an alkaline aqueous solution comprising benzene-1,3,5-tricarboxylic acid or a salt thereof and 1,2-bis(4-pyridyl)ethane or 4,4′-bipyridine at elevated temperature and elevated pressure, wherein the resulting solid raw product is then washed with water, ethanol, or a mixture thereof.

9. (canceled)

10. An adsorbent comprising a metal-organic compound according to claim 2.

11. An adsorbent comprising a metal-organic compound according to claim 3.

12. A method of removing nitrate (NO₃⁻) from an aqueous solution, wherein the method comprises contacting the aqueous solution with an adsorbent, wherein the adsorbent comprises a metal-organic compound according to claim 2.

13. A method of removing nitrate (NO₃⁻) from an aqueous solution, wherein the method comprises contacting the aqueous solution with an adsorbent, wherein the adsorbent comprises a metal-organic compound according to claim 3.

14. A method according to claim 5, wherein the amount of adsorbent is about 12 mg L⁻¹.

15. The method according to claim 8, wherein the aqueous solution of a copper(II) salt is an aqueous solution of Cu(OAc)₂.
